(19) United States
(12) Patent Application Publication
(10) Pub. No.: US 2026/0175238 A1
(43) Pub. Date: Jun. 25, 2026

(54) NOZZLE ATTACHMENT ASSEMBLY

(71) Applicant: Alfred Kärcher SE & Co. KG, Winnenden (DE)

(72) Inventor: Nicola BITAR, Montlingen (CH)

(21) Appl. No.: 19/546,002

(22) Filed: Feb. 20, 2026

Related U.S. Application Data
(63) Continuation of application No. PCT/EP2024/072333, filed on Aug. 7, 2024.

(30) Foreign Application Priority Data
Sep. 8, 2023 (DE) 10 2023 124 295.4

(51) Int. Cl. B05B 1/26; B05B 1/02; B05B 1/14; B05B 1/34; B05B 7/08; B08B 3/02; B41J 2/16

(52) U.S. Cl. CPC B05B 1/26; B05B 1/02; B05B 1/14; B05B 1/34; B05B 7/0815; B08B 3/02; B41J 2/1623

(57) ABSTRACT

The invention relates to a nozzle attachment assembly including a connection element having a coupling point, wherein along an axial direction, a jet preservation element adjoins a jet shaping element, which adjoins the connection element, wherein the jet preservation element includes an outlet opening in fluid-conducting connection with the coupling point, the fluid-conducting connection being configured as an expansion zone delimited in a first plane by cover walls that have a distance and delimited by side walls in a second plane, such that the expansion zone overall replicates a jet geometry of the jet shaping element in such a way that a liquid jet formed thereby is continuously surrounded within the expansion zone by a peripheral gap, and wherein the connection element and/or the jet shaping element and/or the jet preservation element includes at least one gas inlet opening, which opens into the expansion zone.

### CROSS-REFERENCE TO RELATED APPLICATIONS

This application is a continuation of international application number PCT/EP2024/072333, filed on Aug. 7, 2024, and claims the benefit of German application number 10 2023 124 295.4, filed on Sep. 8, 2023, which are incorporated herein by reference in their entirety and for all purposes.

### BACKGROUND OF THE INVENTION

The present invention relates to a nozzle attachment assembly.

The present invention builds explicitly on the learnings and the disclosure of the German patent application DE 10 2023 114 472, to which reference is presently made. The disclosure described there is compatible with the present invention and with regard to its features can be combined with the present invention.

Liquid-operated high-pressure cleaners are known and are used, for example, for cleaning soiled surfaces or for removing varnish and paint residue from surfaces. To this end, liquid is conveyed at a high pressure by means of a high-pressure compressor to an outlet nozzle at which the liquid exits the high-pressure cleaner. The exit hereby takes place in a jet shape that is predetermined by the nozzle. Water or water mixed with a cleaning agent is often used as the liquid. Commencing from the nozzle, the liquid jet then moves toward the surface to be cleaned, wherein the kinetic energy stored in the liquid particles of the liquid jet exerts its cleaning effect when it impacts the surface to be cleaned.

In order to enable a fastest possible cleaning of a surface, it is typically advantageous if the jet used is a flat jet. However, an appropriate nozzle for producing a suitable flat jet is not always available. The reshaping of an already formed liquid jet, for example a round or point jet, is already known and is described, e.g., in DE 29 06 648 C3, in which, to this end, two plates are pivoted laterally into an already formed jet in order to create a flat jet with a variable geometry.

The problem here is that the jet reshaping causes a high efficiency loss and that the transmittable kinetic energy and thus the cleaning power of the liquid jet decreases with increasing distance of the jet shaping element used from the surface to be cleaned. This effect is already noticeable when cleaning in the air, because air, despite its comparatively low density, hinders the movement of the liquid jet and leads to a significant dispersion of the liquid jet after only a few centimeters. This applies particularly if a cleaning is to take place in a significantly more dense/viscous medium. If the liquid jet is used, for example, under water to clean a surface, then there is already a noticeable reduction in the cleaning power after significantly shorter distances from the surface to be cleaned that the liquid jet has to overcome (compared to air).

Until now, to solve this problem, the kinetic energy stored in the water jet was frequently increased by using more powerful compressors in order to be able to provide the required cleaning power in the respective application or by using a nozzle that already produces the desired jet geometry, such that a jet reshaping with the associated losses is able to be avoided. However, this approach has economic and technical limitations.

In accordance with an embodiment of the invention, a cost-effective and energy efficient jet reshaping for a liquid-operated high-pressure cleaning system is provided.

### SUMMARY OF THE INVENTION

In accordance with an embodiment of the invention, a nozzle attachment assembly is provided having the features of independent claim 1.

Advantageous embodiments and further developments result from the dependent claims.

A nozzle attachment assembly is described comprising a connection element having a coupling point arranged on an end face for accommodating a nozzle of a liquid-operated high-pressure cleaner or for spatially fixing the nozzle attachment assembly relative to a liquid jet produced by the nozzle, wherein along an axial direction of extent of the nozzle attachment assembly, a jet shaping element adjoins the connection element and a jet preservation element adjoins the jet shaping element, wherein the jet preservation element comprises an outlet opening on an outlet side facing away from the end face, said outlet opening being in fluid-conducting connection with the coupling point by way of the interior of the nozzle attachment assembly, wherein the fluid-conducting connection in the region of the jet preservation element is configured as an expansion zone, which is delimited in a first plane perpendicular to the axial direction of the extent by cover walls that have a distance h and which is delimited by side walls in a second plane that is perpendicular to the first plane, such that the expansion zone overall replicates a jet geometry of the jet shaping element in such a way that a liquid jet formed by the jet shaping element is continuously surrounded within the expansion zone by a peripheral gap in a radial direction perpendicular to the axial direction of extent, and wherein the connection element and/or the jet shaping element and/or the jet preservation element comprises at least one gas inlet opening, which opens into the expansion zone.

In this way, an already completely formed liquid jet that has left a nozzle of a liquid-operated high-pressure cleaning system is able to be efficiently reshaped depending on a specific application at hand. It is thus possible to forgo the complex provision of nozzles that must be separately adapted to the respective application. The combination of jet shaping element and jet preservation element, which are fixed relative to the already present nozzle by means of the coupling element, enables the efficient usage of said nozzle for a changed application. The at least one gas inlet opening may hereby have a filter or shielding device if necessary to prevent the ingress of foreign particles or contaminants, which could negatively influence the intake of gas. The outlet opening may be substantially rectangular, but may also have slightly rounded corners. In particular, the two short sides may also be slightly curved. The ratio of the short sides to the long sides of the outlet opening may be at least 1:10, for example. The expansion zone may assist in the expansion of the liquid jet, for example by a factor of 20 (in the jet width) along the axial direction of extent, i.e., from the outlet of the flat jet nozzle to the outlet opening of the nozzle attachment assembly.

The distance h may be constant or at least substantially constant. It is also possible, however, that the distance h between the two cover walls increases or decreases in the axial direction of extent seen from the flat nozzle, wherein the increase and decrease can be identified with an opening or closing angle. In particular, the increase or decrease in this context may take place evenly/uniformly, such that a symmetry plane can be found in which the axial direction of extent can extend. The opening or closing angle may preferably be constant. Such a variation of the distance h or the provision of an opening/closing angle can, as necessary, bring about an additional shaping of the jet in the expansion zone behind the actual jet shaping element because these changes first cause a change in the uniformity of the gas flow and as a direct consequence also cause a change in the jet preservation.

By means of this nozzle attachment assembly, when it is coupled to a nozzle forming any liquid jet, for example a point jet nozzle or round jet nozzle, the exiting liquid jet is able to be adapted in its geometry to the geometry predetermined by the jet shaping element and the jet preservation element. The rigid combination of jet shaping element and jet preservation element makes it possible to forgo the precise aligning of the liquid jet at the jet preservation element (with regard to entry direction and entry point), which may be achieved only with great difficulty. By means of the described nozzle attachment assembly, the jet geometry of the (reshaped) liquid jet after exiting the nozzle attachment assembly is advantageously preserved over a greater path/distance, which is achieved by means of the jet preservation element. The term “path” or “distance” is hereby understood to mean, for example, the distance from the nozzle at which the liquid jet is produced by the nozzle at which the “liquid” is being viewed. In particular, the typical dispersion/atomization of the liquid jet at the medium, for example water or air, through which said jet passes, including after the reshaping, can be greatly reduced by means of the provided jet preservation element. This effect is achieved by means of the gas, which is able to enter or be drawn via the gas inlet opening into the expansion zone. Due to the design, the liquid jet does not substantially contact the expansion zone when passing through the jet preservation element and is at a uniform distance from the cover and side walls delimiting the expansion zone all around in a radial direction, such that a peripheral gap with a substantially constant width is formed between the liquid jet and an expansion zone wall. The liquid jet that flows through the expansion zone draws gas through the gas inlet opening according to the principle of a water jet pump (or suction jet pump), said gas entering into the expansion zone and being entrained by the liquid jet. Here, a uniform gas flow forms around the liquid jet in the gap between the surface of the liquid jet and the cover walls and the side walls of the expansion zone, which gas flow completely envelopes the liquid jet even after exiting the outlet opening and advantageously delays a dispersion of the formed liquid jet after exiting the outlet opening. The uniform gas flow that is created thus prevents or delays an undesired atomization or “thickening” of the liquid jet produced by the jet shaping element during the expansion of the jet in the nozzle attachment assembly. The term “uniform” may be understood to mean, but not limited to, for example, a gas flow that has at least some properties of a laminar gas flow or of a turbulence-free gas flow. The term “thickening” can refer to a fanning out of the liquid jet, which intensifies or at least continues with a free path traveled. Due to the mechanism of action, the gas that is drawn in is not sucked into the liquid jet, but instead is accelerated on the surface thereof in the flow direction of the liquid. Although a portion of the kinetic energy contained in the liquid jet is used for the intake of the gas and the liquid jet is thus even somewhat slower when it flows out of the nozzle attachment assembly (compared to a (structurally identical) system without a nozzle attachment assembly that produces a liquid jet with the same geometry as the nozzle attachment assembly), the better bundling of the liquid jet on the surface to be cleaned achieves a higher cleaning power. A proportion of the kinetic energy extracted from the liquid jet hereby remains in the liquid jet in the form of (waste) heat, experiments having shown a measured warming of the liquid jet of 1 to 2° C. with the used test system with the described nozzle attachment assembly. This temperature increase benefits the increase in cleaning performance because warmer liquids typically clean better than colder ones. By using the described nozzle attachment assembly, an energy and liquid savings of in each case 50% (relative to the cleaning power) can be achieved compared to a conventional system (which produces a liquid jet with the same geometry as the nozzle attachment assembly). In addition, the greatly increased cleaning power can also save a great amount of working time. Furthermore, damage to surfaces to be cleaned can be avoided, because the more homogeneous liquid jet comprises no undesirable regions with higher power. Because the nozzle attachment assembly completely predetermines the liquid jet in its geometry and orientation upon entry into the jet preservation element by means of the jet shaping element, a complex and precise alignment of the nozzle attachment assembly relative to the initial liquid jet can be forgone. The radial direction presently denotes, in particular in cylinder coordinates, a radial vector that can be rotated perpendicularly to the axial direction of extent (of the nozzle attachment assembly) and locally about a rotation angle φ and thereby lies perpendicular to the axial direction of extent in any angular position.

Provision may usefully be made that the jet shaping element has a free flow volume that is delimited in the radial direction by an inner surface, wherein the inner surface forms a deflecting area for the liquid jet exiting the nozzle. In this way, an outer geometry of the liquid jet impacting the deflecting area is able to be subsequently changed upon passing through the jet shaping element, wherein the geometry of the liquid jet after passing through the jet shaping element is independent of the geometry of the initial liquid jet.

Provision may further be made that the deflecting area is delimited peripherally by a first self-contained contour line at a first end of the jet shaping element that points toward the connection element and by a second self-contained contour line at a second end of the jet shaping element that points toward the jet preservation element, wherein lying between the two self-contained contour lines are surface elements, which define between said two contour lines planar surface portions of the inner surface or which define at least partially curved surface portions of the inner surface, and the respective surface portion normals of which each has a non-vanishing component that is directed inwardly in the radial direction and counter to the axial direction of extent. In this way, a completely defined jet reshaping is able to take place, the term “completely defined” describing, in particular, that the reshaping takes place or is defined on all sides.

Provision may be made that the first contour line is substantially circular. The term “substantially” hereby typically refers to manufacturing-related tolerances. A circular first contour line enables a particularly efficient introduction/receiving of a point or round jet into the jet shaping element.

Provision may further be made that the second contour line is substantially rectangular. Here, too, the term “substantially” again typically refers to manufacturing-related tolerances. A rectangular second contour line enables an efficient reshaping of the jet entering the jet reshaping element into a flat jet having a thickness and/or maximum width predetermined by the rectangle. Provision may usefully be made that the inner surface of the deflecting area extending between the two contour lines is divisible along a section plane into two opposing inner surface portions in such a way that they are able to be brought into coincidence with one another by a reflection on a section plane and a displacement in the axial direction of extent. In this way, a spatial and temporal offsetting of the reshaping of an “upper” and a “lower” jet half is able to take place. This can have efficiency advantages in the jet reshaping because a simultaneous “compression” (compacting of the flow) from above and below toward the middle of the intended get geometry is avoided.

Provision may also be made that an area comprised by the second contour line within the nozzle attachment assembly defines an absolute narrow point of the fluid-conducting connection with respect to area.

Provision may further be made that the second contour line forms a breakaway edge for a liquid jet shaped by the jet shaping element. In this way, a defined detachment of the liquid jet at the end of the jet shaping element within the nozzle attachment assembly is able to be ensured. Provision may advantageously be made that the deflecting area is of exchangeable configuration. In this way, the nozzle attachment assembly is able to be adapted to different nozzles that provide differently shaped liquid jets without the entire nozzle attachment assembly having to be changed.

The present invention is described in the following by way of example with reference to preferred embodiments.

### BRIEF DESCRIPTION OF THE DRAWINGS

FIG. 1 shows a first outside view of a nozzle attachment assembly;

FIG. 2 shows a second outside view of the nozzle attachment assembly from FIG. 1 from a different perspective;

FIG. 3 shows a first outside view of an alternative nozzle attachment assembly;

FIG. 4 shows the alternative nozzle attachment assembly depicted in FIG. 3 in a first section view;

FIG. 5 shows the nozzle attachment assembly depicted in FIG. 3 in a second section view;

FIG. 6 shows the nozzle attachment assembly depicted in FIGS. 1 and 2 in a first section view;

FIG. 7 shows a section view of a further alternative nozzle attachment assembly;

FIG. 8 shows a detail view of the section of the nozzle attachment assembly from FIG. 6;

FIG. 9 shows a further detail view of a nozzle attachment assembly; and

FIG. 10 shows a further section view of the nozzle attachment assembly depicted in FIG. 3 from a different perspective.

### DETAILED DESCRIPTION OF THE INVENTION

In the following drawings, identical reference signs refer to identical or equivalent components.

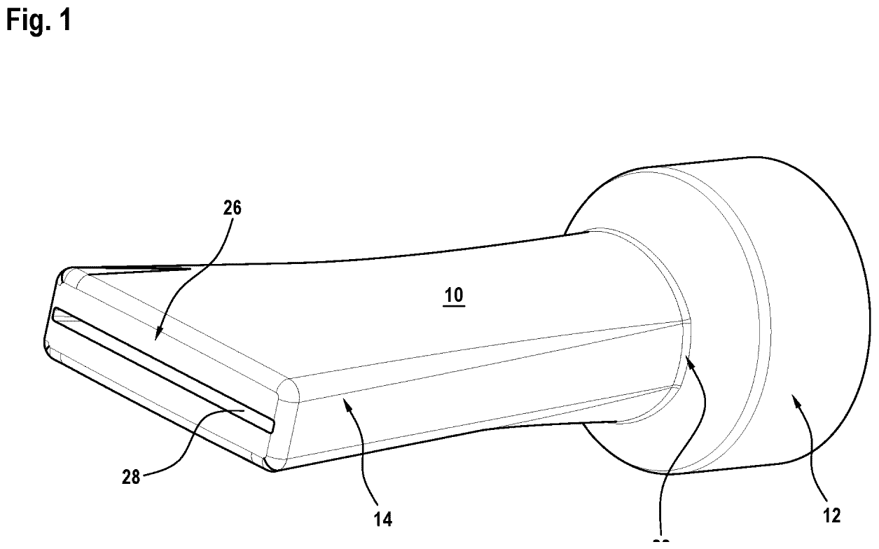

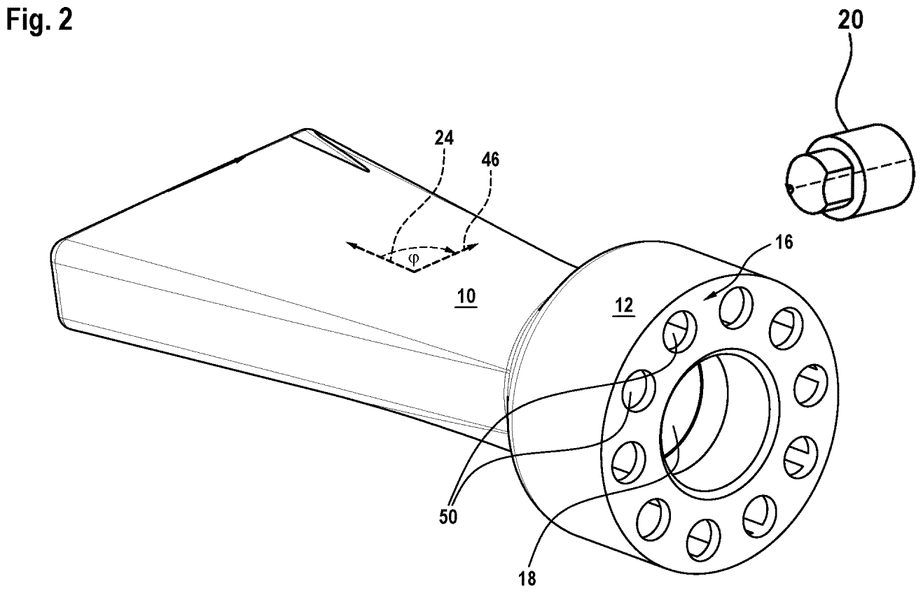

A nozzle attachment assembly 10 is depicted from the outside in FIGS. 1 and 2 from different perspectives. The depicted nozzle attachment assembly 10 comprises an end face 16 on the inlet side, said end face 16 having a coupling point 18. The coupling point 18 may optionally serve to accommodate a nozzle 20 of a liquid-operated high-pressure cleaner or to spatially fix the nozzle attachment assembly 10 relative to a liquid jet produced by a spaced apart nozzle 20. In the Figure, the nozzle 20 is depicted not yet aligned relative to the nozzle attachment assembly 10. The region of the nozzle attachment assembly 10 directly adjoining the end face 16, said region being referred to in the following as a connection element 12, may thus also be referred to as a spacing element.

Commencing from the connection element 12, the nozzle attachment assembly 10 extends in an axial direction of extent 24. A jet preservation element 14 is provided on an end region of the nozzle attachment assembly 10 located opposite the connection element 12 in the axial direction of extent 24. As can be seen, in particular, in FIG. 1, on an outlet side 26 the jet preservation element 14 comprises an outlet opening 28, which, in particular, may be of rectangular configuration. A liquid jet passing through the nozzle attachment assembly 10 is able to exit the latter at the outlet opening. The exiting liquid jet may be configured, in particular, as a flat jet, wherein thickness and width of the liquid jet are each smaller than the height and width of the outlet opening 28, such that the liquid jet does not come into contact with the rims of the outlet opening 28. The functioning of the jet preservation element 14 is described in more detail in the following.

Also shown in FIG. 2 is a radial direction 46, which in cylindrical coordinates denotes a radial vector that can be rotated perpendicularly to the axial direction of extent 24 and locally about a rotation angle q and thereby lies perpendicular to the axial direction of extent 24 in any angular position.

Between the connection element 12 and the jet preservation element 14, the nozzle attachment assembly 10 comprises a jet shaping element 22 that cannot be seen in more detail from the outside. The possible structure of the jet shaping element 22 is described in more detail in the following in connection with the different section views of the nozzle attachment assembly 10.

On the end face 16 of the connection element 12 of the nozzle attachment assembly 10, which is visible in FIG. 2, in particular, a number of gas inlet openings 50 are visible circumferentially around the coupling point 18, by way of which gas inlet openings 50 gas, in particular air, is able to be drawn in to keep the liquid jet shaped by the jet shaping element 22 stable in its shape in the jet preservation element 14. The gas inlet openings continue within the nozzle attachment assembly 10 in the form of gas channels, by way of which gas, in particular air, is drawn in by the liquid jet flowing through the nozzle attachment assembly according to the operating principle of a suction jet pump. The specific positioning of the gas inlet openings 50 on the end face 16 is optional. In particular, more or fewer individual gas inlet openings 50 may be arranged distributed at different positions over the nozzle attachment assembly 10, wherein only the gas channels extending in the interior of the nozzle attachment assembly 10 have to be adapted.

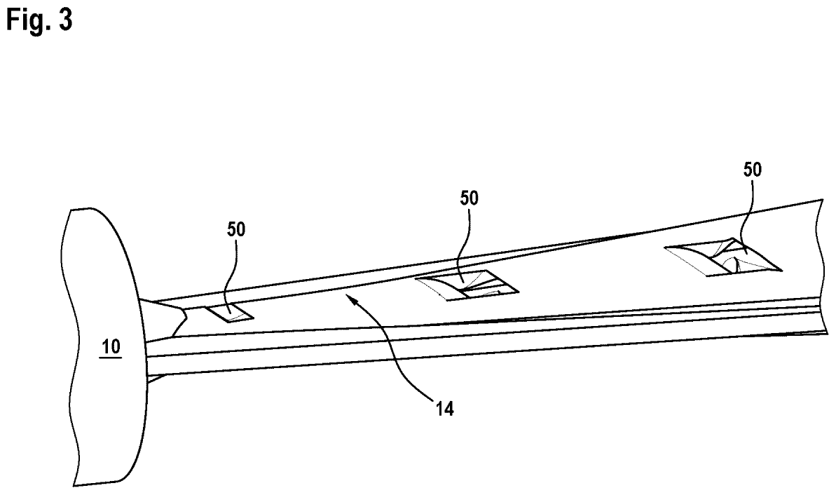

FIG. 3 thus shows, for example, a first outside view of an alternative nozzle attachment assembly 10. Unlike the already known nozzle attachment assembly 10 in FIGS. 1 and 2, in the case of the nozzle attachment assembly 10 depicted from the outside in FIG. 3, it can be seen that the gas inlet openings 50 are arranged directly on the jet preservation element 14 and the jet preservation element 14 looks significantly flatter. That is due to the fact that in the case of the alternative nozzle attachment assembly 10 depicted in FIG. 3, no gas conducting channels thickening the jet preservation element 14 are necessary, since the gas in the region of the jet preservation element 14 is able to be drawn in directly from the outside by the passing liquid jet. Further differences are not directly visible from the outside in the case of the two nozzle attachment assemblies depicted in FIGS. 1 to 3.

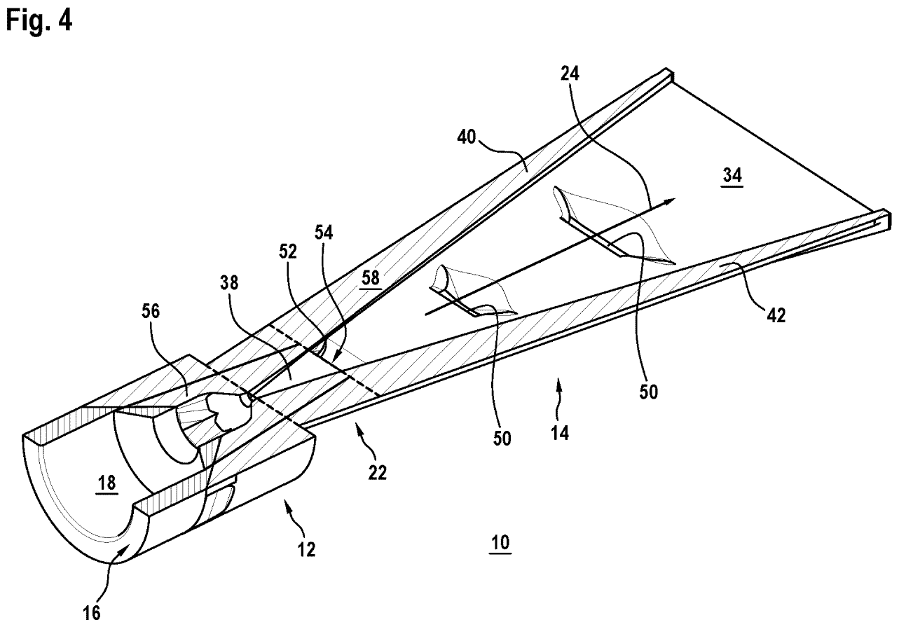

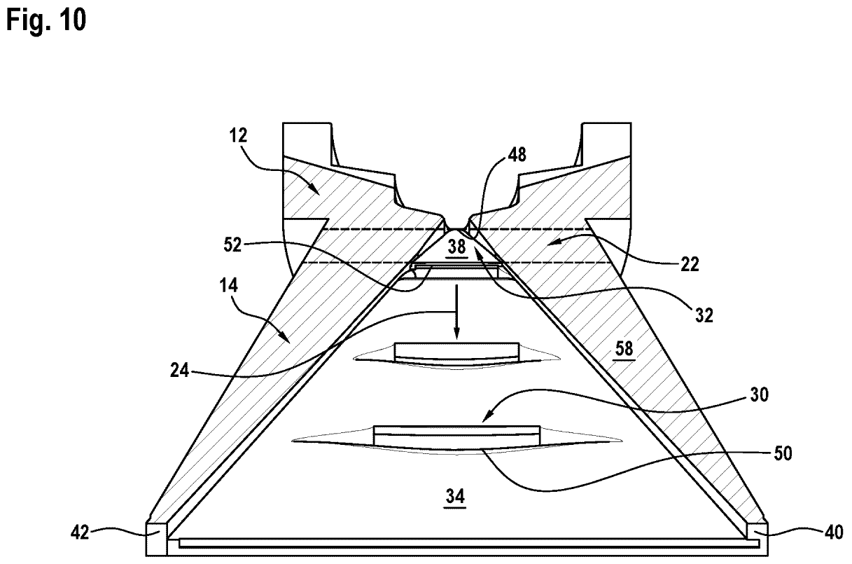

FIGS. 4 and 10 show section views of the alternative nozzle attachment assembly 10 depicted in FIG. 3 from the outside from different perspectives along a section plane 58. Seen this time from the inside to the outside, the distribution of the gas inlet openings 50 on the jet preservation element 14 can be seen. Between the jet preservation element 14 and the connection element 12, the region of the jet shaping element 22 is also marked by dashed lines in FIGS. 4 and 10. The entire nozzle attachment assembly 10 may hereby be produced in one piece or integrally as one component, wherein connection element 12, jet shaping element 22 and jet preservation element 14 adjoin one another in this order along the axial direction of extent and may be fixedly connected to one another in such a way that they are not able to be separated from one another in a non-destructive manner. A releasable connection between the individual elements may also be provided, however. For example, the jet shaping element 22 may be configured as a deflecting area insert 56 that is releasable from the remaining components of the nozzle attachment assembly 10, wherein the deflecting area insert 56 may have, for example, a truncated cone-shaped outer form and is able to be inserted along the axial direction of extent 24 from the connection element 12 into the nozzle attachment assembly 10. The deflecting area insert 56 may optionally project in the axial direction of extent 24 beyond the actual region of the jet shaping element 22, for example in order to achieve a secure fixation within the nozzle attachment assembly 10. In this way, a deflecting area 38 in the deflecting area insert 56 is able to be adapted to different nozzles or different liquid jet geometries without having to redesign the entire nozzle attachment assembly 10.

In the region of the jet shaping element 22, the aforementioned deflecting area 38 is provided, which lies between a first contour line 48 and a second contour line 52. The first contour line 48 hereby constitutes a closed peripheral line on the end of the jet shaping element 22 pointing toward the connection element 12, wherein in each of FIGS. 4 and 10 only a respective lower half of the actual self-contained first contour line 48 is visible. Correspondingly, on the opposite end of the jet shaping element 22 lies the second contour line 52, which is also a self-contained contour line. Due to the section depiction in the section plane 58, in FIGS. 4 and 10 only a half of the two contour lines 48, 52 is visible in each case. Extending between the two contour lines 48, 52 is a passage that narrows in the axial direction of extent 24 of the nozzle attachment assembly and that is delimited by an inner surface 32. The inner surface 32 hereby ultimately extends between the two self-contained contour lines 48, 52. The portion of the inner surface 32 that the liquid jet to be reshaped ultimately impacts is referred to as a deflecting area 38. The deflecting area 38 hereby reshapes the incident jet according to the geometry of the second contour line 52, wherein the latter forms a breakaway edge 54 for the passing liquid jet and ultimately it can be determined that in the region of the second contour line 52 the cross-section that is able to be flowed through by the liquid jet forms a narrow point with respective to area, in particular an absolute narrow point, in the nozzle attachment assembly 10.

The effect achieved by means of the jet preservation element on the liquid jet reshaped by the jet shaping element can be described as follows. The liquid jet exiting the jet shaping element draws in gas, in particular air, while flowing past the gas inlet openings. The gas drawn in is distributed in the expansion zone of the nozzle attachment assembly, which is located in the jet preservation element, a sliding layer forming between the formed liquid jet, which, in particular, may be a flat jet, and the side walls of the jet preservation element. This results in an optimization of the passing liquid jet formed by the jet shaping element. The optimization may hereby be understood to mean, in particular, both a compactification (for example in the sense of bundling the liquid jet) and a homogenization (for example in the sense of an equalization of the energy contained in the liquid jet). After the liquid jet has been optimized and thus preserved, then an ejection of the optimized liquid jet from the nozzle attachment assembly takes place. Thus, this is also the time at which the reshaped liquid jet exits the nozzle attachment assembly used.

The inner surface 32 or deflecting area 38 as part of the inner surface 32 that is visible in FIGS. 4 and 10 and extends between the two contour lines 48, 52 is made of individual surface portions, which altogether form a curved inner surface 32 or a curved deflecting area 38. The curvature of the deflecting area 38 or the inner surface 32 hereby serves to reshape the liquid jet impacting the deflecting area 38 as efficiently as possible, i.e., with the lowest possible energy loss. At the same time, by means of the optionally curved deflecting area 38, a comparatively homogeneous liquid jet is able to be produced that already has a high dimensional stability along its flow direction.

During the reshaping process, the already completely formed (initial) liquid jet, which is typically surrounded on all sides by air and was previously produced by the (external) nozzle 20, impacts the deflecting area 38, such that due to the low compressibility of the incident liquid, a spatial redirection of the volume flow takes place according to the shape predetermined by the deflecting area 38. The second contour line 52 will typically circumscribe a substantially rectangular area and will thereby provide at each of its longer sides a breakaway edge 54 for the reshaped liquid jet. In the region of the breakaway edge 54, the reshaped liquid jet again completely detaches from the inner surface of the nozzle attachment assembly 10 and is thus surrounded again on all sides by an at least thin air layer when it enters the jet preservation element 14. Thus, in the jet shaping element 22, an initial liquid jet is transformed at the deflecting area 38 into a reshaped liquid jet. The jet preservation element 14 then creates a sliding layer of intake air around the reshaped liquid jet, as has already been described above. Said sliding layer can stabilize the liquid jet exiting the jet preservation element 14 in its outer shape over a certain duration/distance, which ultimately benefits the cleaning power when impacting a distant surface.

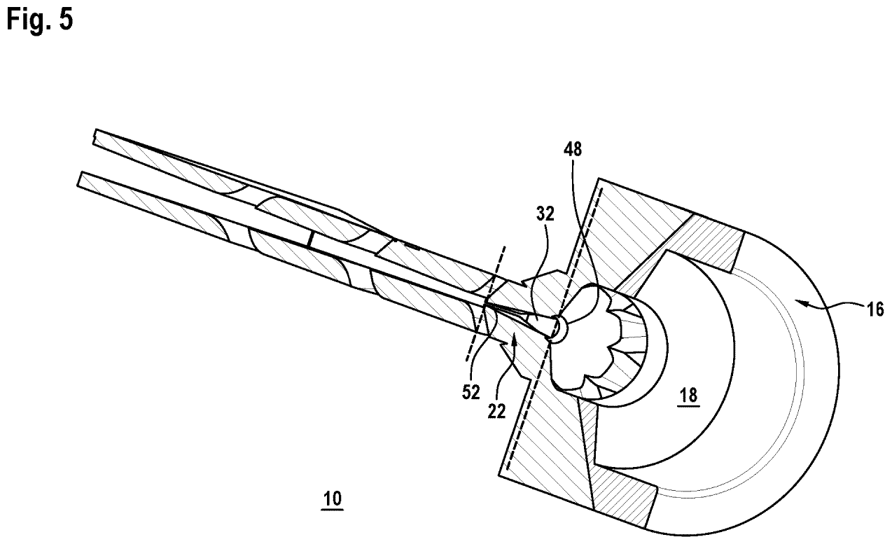

FIG. 5 shows a further section view of the nozzle attachment assembly 10 already known from FIGS. 4 and 10, the now visible section plane, however, being placed perpendicular to the section plane 58 used previously. The jet shaping element 22, which in its interior forms the inner surface 32 between the two self-contained contour lines 48, 52, is again clearly visible. Furthermore, on the end of the connection element 12 pointing toward the jet shaping element 22, gas inlet openings that open toward the interior are visible all around, by way of which gas inlet openings the liquid jet impacting the deflecting area 38 is already able to draw in gas, in particular air, according to the principle of a suction jet pump, said gas then flowing through the jet shaping element 22 laterally in the regions in which the liquid jet does not impact the deflecting area 38 next to the liquid jet that is being reshaped. In the axial direction of extent 24 behind the jet shaping element 22, i.e., in the jet preservation element 14, downstream from the breakaway edge 54 the reshaped liquid jet is separated from the inner wall of the nozzle attachment assembly on all sides by a (thin) gas layer and draws in further gas at the gas inlet openings 50 when it flows past them according to the principle of a suction jet pump.

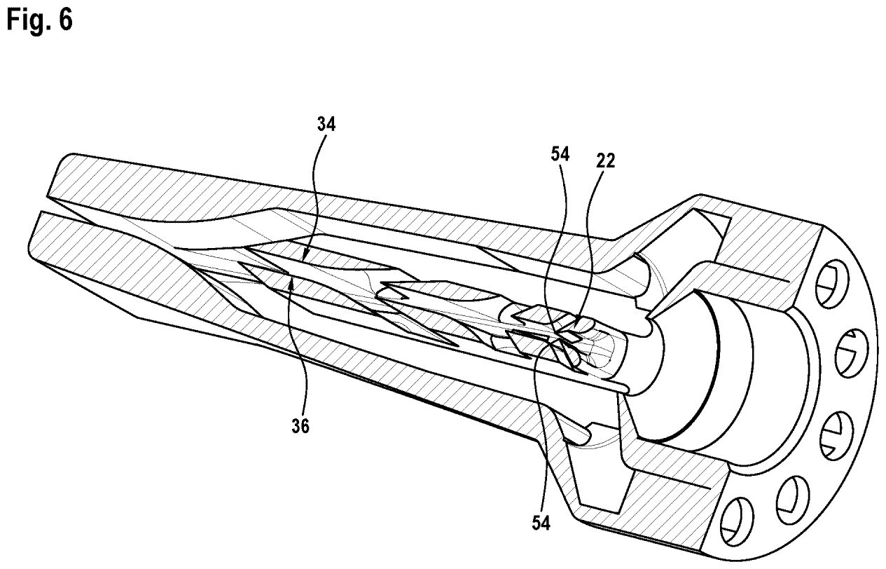

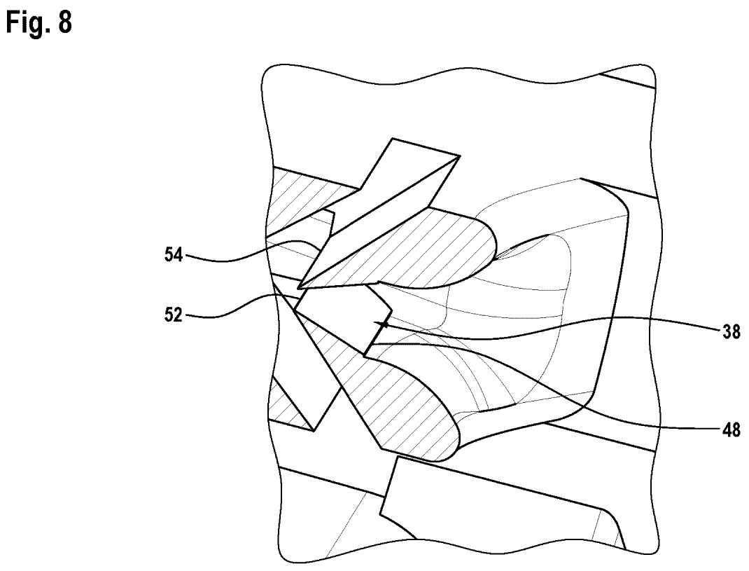

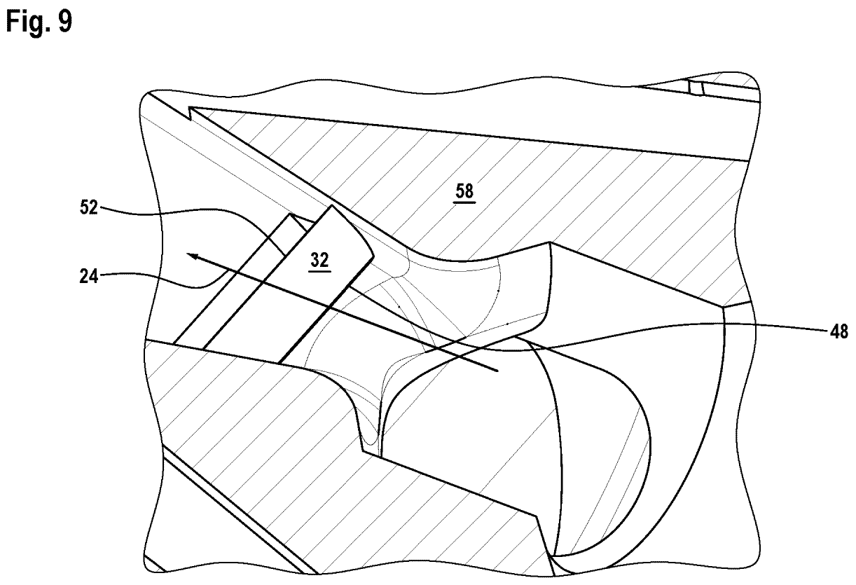

FIGS. 6, 8, and 9 each show sections through the nozzle attachment assembly depicted from the outside in FIGS. 1 and 2, wherein detail views of the region of the jet shaping element 22 are depicted in FIGS. 8 and 9. Unlike the previously described embodiment of the jet shaping element 22, in the case of the jet shaping element 22 depicted in FIGS. 6, 8, and 9, the deflecting area 38, i.e., the portion of the inner surface 32 between the two self-contained contour lines 48, 52 on which the liquid jet is deflected and is thereby (re) shaped, is formed by opposing planar surfaces, which in themselves are not curved. The opposing surfaces may hereby be optimally selected with regard to their respective angle of attack relative to the axial direction of extent 24. In particular, provision may also be made that the two opposing surfaces have mutually different angles of attack. Provision may further be made that the liquid jet to be reshaped, in particular in the case of differing angles of attack, impacts the two surfaces to unequal degrees and thus is reshaped unevenly. This can be understood to mean, in particular, that more of the liquid jet to be reshaped impacts and is reshaped by one of the two planar surfaces. Here, the planar surface impacted by more of the liquid jet to be reshaped may be, in particular, that surface with a lesser/smaller angle of attack. The different angles of attack and the unequal distribution of the incident amount of liquid may hereby be coordinated with one another in such a way that the reshaping of the liquid jet in the jet shaping element 22 produces no force component deviating from the axial direction of extent 24, which would possibly have to be compensated by a user.

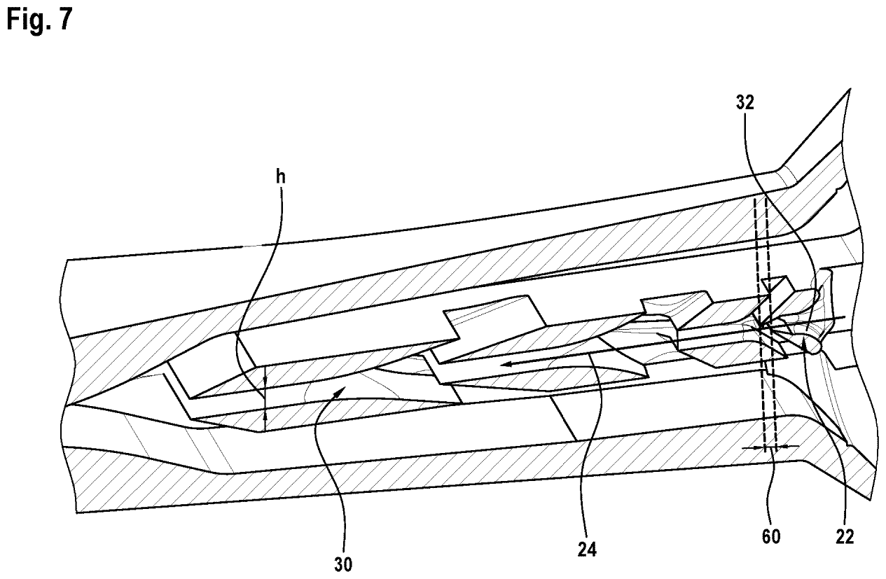

FIGS. 6 and 7 show in the region of the jet preservation element 14 a structure in which the gas drawn in, in particular air, is conducted within the nozzle attachment assembly 10 commencing from the gas inlet openings 50. This structure constitutes the aforementioned gas channels. In the interior of the jet preservation element 14, cover walls 34, 36 are hereby provided, between which the liquid jet flows, wherein it is separated from each of them by a respective gas layer.

FIG. 7 shows a section through an alternative nozzle attachment assembly 10 in which a displacement 60 along the axial direction 24 of surface portions of the inner surface 32 or of the deflecting area 38 located opposite one another along the section plane is visible. In this way, a jet shaping in the jet shaping element 22 is performed on the opposite sides of the liquid jet flowing through the jet shaping element 22 in the axial direction of extent 24 in a spatially and temporally offset manner, which may be advantageous with regard to energy losses that occur within the liquid jet.

The features of the invention disclosed in the preceding description, in the drawings, and in the claims may be essential both individually and in any combination for the realization of the invention.

### REFERENCE NUMERAL LIST

10 nozzle attachment assembly
12 connection element
14 jet preservation element
16 end face
18 coupling point
20 nozzle
22 jet shaping element
24 axial direction of extent
26 outlet side
28 outlet opening
expansion zone
32 inner surface
34 cover wall
36 cover wall
38 deflecting area
40 side wall
42 side wall
46 radial direction
48 first contour line
50 gas inlet opening
52 second contour line
54 breakaway edge
56 deflecting area insert
58 section plane
60 displacement
h distance

1. A nozzle attachment assembly comprising
a connection element having a coupling point arranged on an end face for accommodating a nozzle of a liquid-operated high-pressure cleaner or for spatially fixing the nozzle attachment assembly relative to a liquid jet produced by the nozzle,
wherein along an axial direction of extent of the nozzle attachment assembly, a jet shaping element adjoins the connection element and a jet preservation element adjoins the jet shaping element,
wherein the jet preservation element comprises an outlet opening on an outlet side facing away from the end face, said outlet opening being in fluid-conducting connection with the coupling point by way of the interior of the nozzle attachment assembly,
wherein the fluid-conducting connection in the region of the jet preservation element is configured as an expansion zone, which is delimited in a first plane perpendicular to the axial direction of the extent by cover walls that have a distance h and which is delimited by side walls in a second plane that is perpendicular to the first plane, such that the expansion zone overall replicates a jet geometry of the jet shaping element in such a way that a liquid jet formed by the jet shaping element is continuously surrounded within the expansion zone by a peripheral gap in a radial direction perpendicular to the axial direction of extent, and
wherein at least one of i) the connection element and ii) the jet shaping element and iii) the jet preservation element comprises at least one gas inlet opening, which opens into the expansion zone.

2. The nozzle attachment assembly in accordance with claim 1, wherein the jet shaping element has a free flow volume, which is delimited in the radial direction by an inner surface, wherein the inner surface forms a deflecting area for the liquid jet exiting the nozzle.

3. The nozzle attachment assembly in accordance with claim 2, wherein the deflecting area, at a first end of the jet shaping element that points toward the connection element, is delimited peripherally by a first self-contained contour line and, at a second end of the jet shaping element that points toward the jet preservation element, is delimited by a second self-contained contour line, wherein located between the two self-contained contour lines are surface elements, which define between said two contour lines planar surface portions of the inner surface or which define at least partially curved surface portions of the inner surface, and the respective surface portion normals of which each comprise a non-vanishing component that is directed inwardly in the radial direction and counter to the axial direction of extent.

4. The nozzle attachment assembly in accordance with claim 3, wherein the first contour line is substantially circular.

5. The nozzle attachment assembly in accordance with claim 3, wherein the second contour line is substantially rectangular.

6. The nozzle attachment assembly in accordance with claim 2, wherein the inner surface of the deflecting area extending between the two contour lines is divisible along a section plane into two opposite inner surface portions in such a way that they are able to be brought into coincidence with one another by way of a reflection on the section plane and a displacement in the axial direction of extent.

7. The nozzle attachment assembly in accordance with claim 3, wherein an area comprised by the second contour line within the nozzle attachment assembly defines an absolute narrow point with respect to area.

8. The nozzle attachment assembly in accordance with claim 3, wherein the second contour line forms a breakaway edge for a liquid jet shaped by the jet shaping element.

9. The nozzle attachment assembly in accordance with claim 2, wherein the deflecting area is of exchangeable configuration.
